(19) United States
(12) Patent Application Publication
(10) Pub. No.: US 2008/0295760 A1
(43) Pub. Date: Dec. 4, 2008

(54) Magnetic Actuated Wear Indicator for Personal Care Appliances

(75) Inventor: Ytsen Wielstra, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 12/089,244

(22) PCT Filed: Oct. 4, 2006
(86) PCT No.: PCT/IB06/53636

§ 371 Date: Aug. 6, 2008

(30) Foreign Application Priority Data
Oct. 4, 2005 (US) 60/723385

(51) Int. Cl. G01D 5/12

(52) U.S. Cl. 116/204

(57) ABSTRACT

The wear indicator (10) is for a workpiece portion of a personal care appliance such as a power toothbrush (IS). The wear indicator includes a member of water-soluble material which has magnetic particles positioned therein. Upon repeated contacts with water, which correlates with use of the device, the member dissolves or swells, depending on the material selected. A magnet positioned adjacent the member influences the position of the magnetic particles in the member, aligning them into a three-dimensional image which is recognizable by the user, wherein the appearance of the image correlates with sufficient wear on the workpiece that it should be replaced.

This invention relates generally to personal care appliances, and more specifically concerns a wear indicator for such an appliance, such as for a brushhead portion of a power toothbrush.

It is typically important for those personal care appliances having a workpiece which will deteriorate and lose effectiveness after a certain number of uses to incorporate a reliable wear indicator within the appliance which indicates clearly to the user that it is time to replace the workpiece. It is important that the indication be reliable relative to the actual physical condition of the workpiece and further that the indication be clear and readily interpretable by a user. Still further, it is usually important that a wear indicator be convenient to implement in a particular appliance of interest and not add significant additional expense to the appliance.

Wear indicators are well known for various appliances. These include devices which count the number of uses of the appliance, as well as devices which detect actual physical wear on the workpiece which occurs because of use. For example, in the case of a toothbrush, as the bristles wear away during use, various indicator arrangements within the bristles are revealed, including a different color, as the wear on the bristles reaches a selected depth.

Accordingly, it is desirable to have a workpiece wear indicator which is both reliable, i.e. the indication provided correlates with the actual physical condition of the workpiece, and which is clearly interpretable by a user that it is time to replace the workpiece. As indicated above, one example of such a personal care appliance and a workpiece associated therewith which uses a wear indicator is a brushhead portion of an electric toothbrush. Another example is a blade or cutting head on an electric shaver. Other examples will readily occur to one skilled in the art.

Accordingly, the invention is a wear indicator for a workpiece portion of a personal care appliance, comprising a first member having magnetic particles therein, wherein the member is characterized by a reaction to repeated contact with water over time such that as the appliance is used, the layer member gradually changes state, permitting the magnetic particles therein to become oriented, under the influence of an adjacent magnet member, into a recognizable image, which indicates that the workpiece should be replaced; and a magnet member positioned close to the first member, such that it can influence the position of the magnetic particles in the first member into said recognizable image upon a sufficient change of state from the original condition of the first member, wherein the appearance of said recognizable image indicates that the workpiece should be replaced.

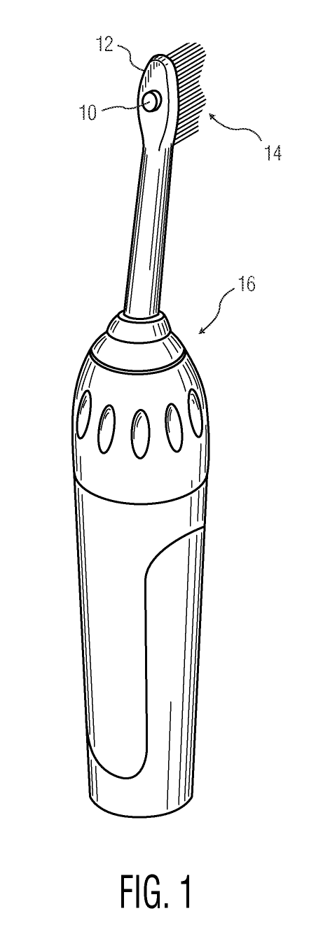

FIG. 1 shows a personal care appliance, in particular an electric toothbrush, showing in general the position of the wear indicator of the present invention.

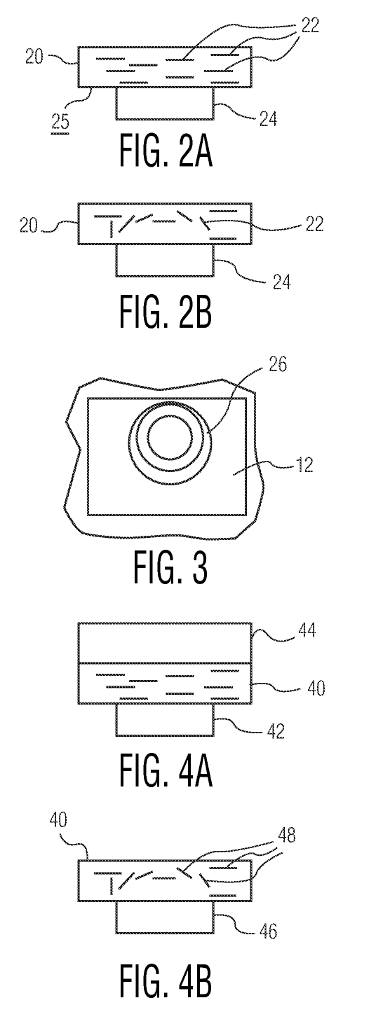

FIGS. 2A and 2B show a first embodiment of the present wear indicator.

FIG. 3 shows a representative image which is presented to the user when the wear indicator determines that it is time to replace the workpiece.

FIGS. 4A and 4B show a second embodiment of the wear indicator.

FIG. 1 shows a wear indicator of the present invention incorporated in an electric toothbrush. The wear indicator, shown generally at 10, is embedded into a base portion 12 of brushhead 14, which comprises a part of a conventional electric toothbrush 16. The wear indicator 10 can be used for a wide variety of electric toothbrush arrangements. Also, it should be understood that the wear indicator 10 described herein can be used on other personal care appliances which include a workpiece which requires periodic replacement for continuing effective action.

A first embodiment of the wear indicator 10 is shown in FIGS. 2A and 2B. The wear indicator includes a water-soluble material member/layer 20. The size of layer 20 can vary, but in one embodiment, it could be 10 100 microns thick. The primary requirement is that the magnetic particles have space to move (reorient) when a magnetic field forces the particles into a different orientation and such that the effect is visible.

Examples of appropriate materials comprising the water-soluble member 20 include water-soluble polymers, such as polyvinyl alcohol (PVA), polyvinyl pyrrolidon (PVP) and other similar materials. Layer 20 has magnetic particles 22 embedded therein. The magnetic particles 22 can comprise basically any material which is responsive to magnetic action, such as various iron oxides and other materials, including specialized pigments which respond to magnetic action, such as iron oxide coated flake-like pigments. The particles 22 are embedded in member 20 in a random fashion with no particular arrangement or oriented state.

The wear indicator 10 also includes a magnet member 24 positioned adjacent to or in contact with the lower surface 25 of member 20.

During use of the appliance, the member/layer 20 will come into contact with water. Member 20 becomes wet and either begins to slowly dissolve or to swell. At a reliable point, following sufficient dissolution/swelling of the material in layer 20, due to repeated contacts with water as a result of repeated uses, the particles 22 will gradually move/reorient themselves under the influence of magnetic element 24, until they form a three-dimensional image, along the magnetic field lines produced by the magnetic member. The size of the magnet and the orientation of the magnetic poles will determine the visual effect. The three-dimensional image indicates clearly to the user that replacement of the workpiece, e.g. the toothbrush brushhead, is appropriate. Such an image is shown at 26 in FIG. 3. The round 3 D image 26 is produced by the use of a round magnet. Other image configurations can be produced using different shaped magnet elements. FIG. 2B shows the reorientation of particles 22 into the 3 D image of FIG. 3, from the planar arrangement shown in FIG. 2A.

The sensitivity of the wear indicator 10 can be changed in several ways. First, the sensitivity of member 20 can be varied by adjusting the chemical composition of the material and, in the case of polymers, adjusting the crosslink density. This will change the rate/manner of dissolution/swelling of the water-soluble member, so as to provide an accurate, reliable indication of wear of the workpiece. The strength of the magnet member 24 can also be varied. Further, different magnet configurations can be used which have the capability of producing particular image forms.

FIGS. 4A and 4B show another embodiment of the invention, which includes a structure similar to FIGS. 2A and 2B, with a water-soluble, magnetic particle-containing member 40 and a magnet member 42. This embodiment includes an upper layer 44 of water-soluble material on top of member 40. Member 44 has no magnetic particles, but is characterized by gradually dissolving upon contact with water, and hence delaying the exposure of the active member 40 (with the magnetic particles) to water. The thickness of the delay layer 44 can be adjusted so that the unit as a whole can provide an accurate indication of wear, based on use. FIG. 4B shows the delay layer 44 completely dissolved, and the realignment of magnetic particles 48 within member 40 into a recognizable configuration, such as shown in FIG. 3.

Hence, it should be understood that various arrangements of water-soluble elements can be used in combination with a magnetic member to provide a clear and accurate indication of workpiece wear for the purpose of an appropriate replacement time.

Although a preferred embodiment of the invention has been disclosed for purposes of illustration, it should be understood that various changes, modifications and substitutions can be incorporated within in the invention without departing from the spirit of the invention which is defined by the claims which follows.

1. A wear indicator for a workpiece portion of a personal care appliance, comprising: a first member having magnetic particles therein, wherein the member is characterized by a reaction to repeated contact with water over time such that as the appliance is used, the layer member gradually changes state, permitting the magnetic particles therein to become oriented, under the influence of an adjacent magnet member, into a recognizable image, which indicates that the workpiece should be replaced; and a magnet member positioned close to the first member, such that it can influence the position of the magnetic particles in the first member into said recognizable image upon a sufficient change of state from the original condition of the first member, wherein the appearance of said recognizable image indicates that the workpiece should be replaced.

2. The wear indicator of claim 1, wherein the recognizable image is three-dimensional.

3. The wear indicator of claim 1, wherein the first member comprises a material which gradually dissolves upon repeated contact with water, and wherein the first member is sufficiently dissolved, after a sufficient number of uses has occurred, to reliably indicate that the workpiece should be replaced, to permit the orientation of the particles in the recognizable image.

4. The wear indicator of claim 1, wherein the first member comprises a material which gradually swells upon repeated contact with water, and wherein the first member is sufficiently swollen after a sufficient number of uses has occurred to reliably indicate that the workpiece should be replaced, that the orientation of the particles into the recognizable shape can occur.

5. The wear indicator of claim 1, including a second member, which is water-soluble, positioned on top of the first member, which delays contact by water with the first layer until after the second layer has dissolved, which occurs after a selected amount of use of the appliance.

6. The wear indicator of claim 1, wherein the appliance is a toothbrush and the workpiece is a brushhead which must be periodically replaced.

7. The wear indicator of claim 6, wherein the wear indicator is positioned on the brushhead.
